(19) United States
(12) Patent Application Publication
(10) Pub. No.: US 2024/0210900 A1
(43) Pub. Date: Jun. 27, 2024

(54) AUTOMATIC DOOR OPERATOR IN ENTRANCE SYSTEM

(71) Applicant: Assa Abloy Entrance Systems AB, Landskrona (SE)

(72) Inventor: Stefan PAULSSON, Odakra (SE)

(21) Appl. No.: 18/288,325

(22) PCT Filed: May 3, 2022
(86) PCT No.: PCT/EP2022/061748

§ 371 Date: Oct. 25, 2023

(30) Foreign Application Priority Data
May 4, 2021 (SE) 2130120-5

(51) Int. Cl. G05B 9/02

(52) U.S. Cl. CPC G05B 9/02

(57) ABSTRACT

ASSA ABLOY Entrance Systems AB has developed control arrangement (100) for an entrance system (300) is disclosed herein. The control arrangement (100) comprises a controller module (30) and a sensor module (20), the controller module (30) being for providing control data to the sensor module (20) and the sensor module (20) being for providing sensor data to the controller module (30). The sensor module (20) is configured to provide a safety signal representing the sensor data, and retrieve the control data from the safety signal. The controller module (30) is configured to modulate a current of the safety signal, the modulated current representing the control data, and retrieve the sensor data from the safety signal.

### TECHNICAL FIELD

The present invention generally relates to entrance systems. More specifically, the present invention relates to automatic door operators for use in entrance systems. The present invention also relates to an associated control arrangement and method.

### BACKGROUND

Entrance systems are frequently used in both private and public areas, and are operating during long periods of time and under various conditions in terms of time of day, time of week, time of year, passage frequencies, etc. Automatic door operators are typically used for controlling an electrical motor to open and close door members of the entrance system. The opening and closing procedures are performed so that entrance and exit to buildings, rooms and other areas are facilitated.

Entrance systems are often equipped with safety measures so that accidents caused by movement of door members can be prevented, or at least mitigated. For instance, safety measures can involve sensor modules that are configured for detecting objects or persons being in the vicinity of the door members. Upon detection, the obtained signals are generally transmitted to the automatic door operator for control of the actuation of the door members accordingly. More sophisticated sensor modules also have functionalities of serially communicating data to automatic door operators. Such data may include, in addition to the obtained signals, information regarding e.g. what type of object has been detected, where an object is detected, movement speed of said detected object, and so forth. This data may, for instance, be used for providing a safer environment in and around entrance systems.

Some automatic door operators are not only equipped for receiving information from sensor modules, as it is also wanted to serially communicate data to the sensor module. Hence, such automatic door operators are typically equipped with communication means, so that relevant information can be transmitted to the associated sensor module. For instance, this type of relevant information may include set-up parameters of the sensor module, relevant entrance system characteristics, external factors, and so forth.

Prior art solutions that aim to solve the above presented problems typically involve installing complex and expensive communication systems. Hence, the complexities of both the sensor modules and automatic door operators are increased by adding additional pins for enabling such two-way communication between automatic door operators and sensor modules. It is thus desired to provide a solution for enabling both serial data communication and safety signaling in a cost-efficient manner, while simultaneously complying with safety standards.

After insightful reasoning, the present inventor has identified a solution to the above presented problem. Accordingly, it is an object of the present invention to provide a simple, safe and cheap solution to for handling serial data communication and safety signaling in automatic door operators.

### SUMMARY

An object of the present disclosure is to provide an entrance system, an automatic door operator, a method and a control arrangement, which seek to mitigate, alleviate, or eliminate one or more of the above-identified deficiencies in the art and disadvantages singly or in any combination.

In a first aspect, a control arrangement for an entrance system is provided. the control arrangement comprises a controller module and a sensor module, the controller module being for providing control data to the sensor module and the sensor module being for providing sensor data to the controller module, said sensor module being configured to provide a safety signal representing the sensor data, and retrieve the control data from the safety signal; said controller module being configured to modulate a current of the safety signal, the modulated current representing the control data, and retrieve the sensor data from the safety signal.

In light of the first aspect, the controller module can communicate with the sensor module by modulating the current of the safety signals. The first aspect thus effectively provides a universal standard for the sensor module to be connected to a standard port at the controller module. Since both safety signaling and serial data communication is being handled in one signal, the number of pins required in the standard port is thereby reduced.

According to one embodiment, the safety signal is a dynamic safety signal comprising a plurality of pulses, wherein the sensor module is configured to modulate pulse widths of said plurality of pulses, said modulated pulse widths representing a bit pattern comprising at least one bit, wherein the controller module is configured to retrieve the sensor data by translating said bit pattern representation.

According to one embodiment, the safety signal is a dynamic safety signal comprising a plurality of pulses appearing at a predetermined frequency, wherein the sensor module is configured to modulate the predetermined frequency, said modulated frequency representing a bit pattern comprising at least one bit, wherein the controller module is configured to retrieve the sensor data by translating said bit pattern representation.

According to one embodiment, the sensor data includes detection information, sensor module characteristics, maintenance information, process information and/or positional information.

According to one embodiment, the control arrangement further comprises an interface circuitry, wherein the sensor module and the controller module are coupled by means of said interface circuitry over a single wire.

According to one embodiment, the interface circuitry is a duplex communication interface.

According to one embodiment, the interface circuitry is adapted to provide galvanic isolation between the sensor module and the controller module.

According to one embodiment, the interface circuitry comprises a transistor unit and a load, and wherein the controller module is configured to modulate the electrical resistance of the load through control of the transistor unit.

According to one embodiment, modulating the electrical resistance of the load generates said modulated current, said modulated current representing a bit pattern comprising at least one bit, wherein the sensor module is configured to retrieve control data from the one or more dynamic safety signals by translating said bit pattern representation.

According to one embodiment, said control data comprises at least one of installation parameters, entrance system characteristics and/or maintenance information.

According to one embodiment, the sensor module comprises one or more sensor units, said one or more sensor units being optical sensors; ultrasonic sensors; inductive sensors; galvanic sensors; magnetic sensors; photoelectric sensors; capacitive sensors; pneumatic sensors; weight or pressure sensors; cameras; electromechanical switches; or any combination thereof.

In a second aspect, an automatic door operator comprising a control arrangement according to the first aspect is provided.

In a third aspect, an entrance system comprising an automatic door operator according to the second aspect and one or more movable door members are provided, wherein the control arrangement is configured to cause controlled actuation of the one or more movable door members at least in part based on the sensor data.

According to one embodiment, said controlled actuation involves inhibiting, stopping or reverting current or future movement of at least one of the one or more movable door members.

In a fourth aspect, a method for communicating control data and sensor data between a sensor module and a controller module in an entrance system is provided. The method comprises providing a safety signal representing the sensor data; retrieving the control data from the safety signal; modulating a current of the safety signal, the modulated current representing the control data; and retrieving the sensor data from the safety signal.

It should be emphasized that the term “comprises/comprising” when used in this specification is taken to specify the presence of stated features, integers, steps, or components, but does not preclude the presence or addition of one or more other features, integers, steps, components, or groups thereof. All terms used in the claims are to be interpreted according to their ordinary meaning in the technical field, unless explicitly defined otherwise herein. All references to “a/an/the [element, device, component, means, step, etc.]” are to be interpreted openly as referring to at least one instance of the element, device, component, means, step, etc., unless explicitly stated otherwise. The steps of any method disclosed herein do not have to be performed in the exact order disclosed, unless explicitly stated.

### BRIEF DESCRIPTION OF THE DRAWINGS

The foregoing will be apparent from the following more particular description of the example embodiments, as illustrated in the accompanying drawings in which like reference characters refer to the same parts throughout the different views. The drawings are not necessarily to scale, emphasis instead being placed upon illustrating the example embodiments.

FIG. 1 is a schematic illustration of an entrance system comprising an automatic door operator and a control arrangement according to one embodiment.

FIG. 2 is a schematic illustration of a control arrangement according to one embodiment.

FIG. 3 is a schematic illustration of pulse width modulation according to one embodiment.

FIG. 4 is a schematic illustration of frequency modulation according to one embodiment.

FIG. 5 is a schematic illustration of current modulation according to one embodiment.

FIGS. 6a-b are a schematic illustration of current modulation according to one embodiment.

FIG. 7 is a block diagram of a method for communicating data according to one embodiment.

### DETAILED DESCRIPTION OF EMBODIMENTS

Embodiments of the invention will now be described with reference to the accompanying drawings. The invention may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the particular embodiments illustrated in the accompanying drawings is not intended to be limiting of the invention. In the drawings, like numbers refer to like elements.

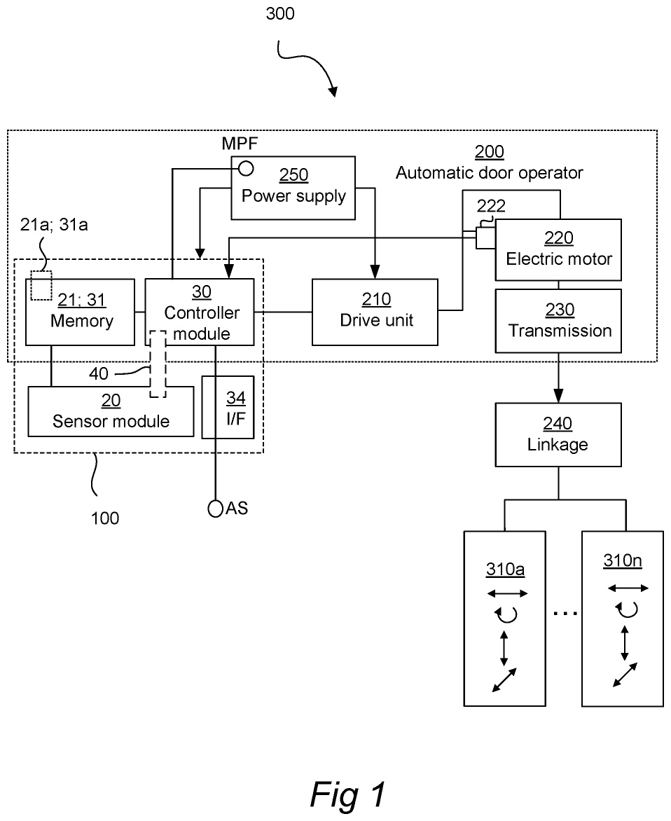

With reference to FIG. 1, a schematic block diagram of an embodiment of an entrance system 300 is shown, in which the inventive aspects of the present disclosure may be applied. In this particular example, the entrance system 300 comprises an automatic door operator 200 having a control arrangement 100, a linkage 240, and one or more movable door members 310a-n. The entrance system 300 may be designed for installation in a building to control access into the building from the outside of said building, or between different sections of the building. The automatic door operator 200 is coupled to cause movement of the one or more movable door members 310a-n from at least a closed position in which passage through said entrance system 300 is prevented, to an open position in which passage is admitted. The linkage 240 is coupled with the movable door members 310a-n to take part in their opening and closing movement. As can be seen in FIG. 1 (indicated by the four arrows on the respective doors), the door members 310a-n may be either one of a sliding door member, a revolving door member, a lifting door member, or a swing door member.

In addition to the control arrangement 100 and its associated components, the automatic door operator 200 further comprises a power supply 250, a drive unit 210, a revolution counter 222, an electric motor 220 and a transmission 230. The automatic door operator 100 is however not restricted to having these particular components, as other arrangements may be realized.

The electric motor 220 is connected to the transmission 230. An output shaft (not shown) of the transmission 230 rotates upon activation of the electric motor 220 by the drive unit 210. The output shaft is connected to the linkage 240, which translates the motion of the output shaft into a movement of one or more door movable members 310a-n of the entrance system 300.

The power supply 250 of the automatic door operator 300 is adapted to supply power to the drive unit 210, and preferably also to the control arrangement 100 and other components of the automatic door operator 200. Alternative embodiments are however possible in which the control arrangement 100 and other components of the automatic door operator 200 are powered by separate arrangements, such as another power supply, a battery, etc.

The automatic door operator 200 may furthermore comprise one or more additional sensor functions MPF; AS configured for detecting emergency situations. The control arrangement 100 is further responsive to the additional sensor functions MPF; AS to enter an evacuation mode. In the evacuation mode, the control arrangement 100 is configured for controlling actuation of the electric motor 220 to generate torque for causing the movable door members 310a-n in the entrance system 300 to move from closed position to open position and maintain in the open position even when there is a power failure in the power supply 250. Such power failure may e.g. involve an interruption in the power provided as e.g. AC mains (not shown). In this case, the electric motor 220 may be power supplied by a battery.

In these or other embodiments, the additional sensor function AS may comprise means for receiving an external incoming alarm signal, such as a signal from a smoke detector, fire heat detector, remote alarm center, etc. To this end, the automatic door operator 200 may have a wired or wireless communication interface 34 for receiving the external incoming alarm signal AS. The interface 34 may, for instance, be compliant with GSM, UMTS, LTE, D-AMPS, CDMA2000, FOMA, TD-SCDMA, TCP/IP, Ethernet, Bluetooth, WiFi (e.g. IEEE 802.11, wireless LAN), Near Field Communication (NFC), RF-ID (Radio Frequency Identification), Infrared Data Association (IrDA), without limitation and in any combination.

The revolution counter 222, such as an encoder or other angular sensor, may provided at the electric motor 220 to monitor the revolution of a motor shaft of the electric motor 220. The revolution counter 222 is connected to an input of the control arrangement 100. The control arrangement 100 may be configured to use one or more readings of the revolution counter 222, typically a number of pulses generated as the motor shaft rotates, for determining a current angular position, e.g. angles of the movable door members 310a-n of the entrance system 300.

The control arrangement 100 comprises a controller module 30. The controller module 30 is configured for performing different functions of the automatic door operator 200. In the shown embodiment, the control arrangement 100 comprises a memory 31 associated with the controller module 30. The controller module 30 may comprise a processing unit that is implemented in any known technology, including but not limited to microcontroller, processor (e.g. PLC, CPU, DSP), FPGA, ASIC or any other suitable digital and/or analog circuitry capable of performing the intended functionality. The memory 31 associated with the controller module 30 may be implemented in any known memory technology, including but not limited to E(E)PROM, S(D)RAM or flash memory. In some embodiments, the memory 31 may be integrated with or internal to the controller module 30. As seen at 31a, the memory 31 may store program instructions 31a for execution by the controller module 30, as well as temporary and permanent data used by the controller module 30.

The control arrangement 100 further comprises a sensor module 20 being operatively connected to the controller module 30 via an interface circuitry 40. As such, the sensor module 20 is in a wired connection with the controller module 30.

In one embodiment, the safety module 20 is arranged as a mounting structure, which is mounted to at least one of the one or more movable door members 310a-n. The mounting structure may be fastened using any known fastening means such as e.g. screws, bolts, nuts, or adhesive materials.

In different embodiments of the present disclosure, the sensor module 20 may vary in complexity. In the simplest of embodiments, the sensor module 20 is one or more bipolar junction transistors (BJTs), e.g. NPN/PNP-based sensors, or MOSFETs that are capable of generating an output value switching between high and low values. Alternatively, the sensor module 20 may be a “smart” sensor module 20 comprising a plurality of different components and functionalities. For instance, the sensor module 20 may comprise a carrier wave generation unit adapted to generate carrier waves as an output value. The sensor module 20 may also comprise a pulse-width modulator unit and/or a frequency modulator unit, being adapted to modulate pulse widths and/or frequencies of said carrier waves. To this end, the sensor module 20 may comprise a processing unit having an associated memory 21 that is storing program instructions 21a being executable by said processing unit. The technologies used for this purpose may be similar to those of the processing unit and memory 31 of the controller module 30.

In one embodiment, the sensor module 20 may been arranged in accordance with a plurality of transmitter units coupled with associated receiver units at respective movable door members 310a-n. The transmitter and receiver units may each comprise an array of light emitting diodes. Each transmitter unit may be configured to communicate a light signal to its associated receiver unit. The light signal may be based on known technologies such as infrared light or similar.

In alternative embodiments, the sensor module 20 may comprise one or more sensor units, wherein the one or more sensor units are ultrasonic sensors, inductive sensors, optical sensors, galvanic sensors, magnetic sensors, photoelectric sensors, capacitive sensors, pneumatic sensors, weight or pressure sensors, cameras, electromechanical switches, or any combination thereof.

The output value from the sensor module 20 is directly associated with a safety signal. As will be apparent from the forthcoming description, the safety signal may be used to convey information to indicate that the sensor module 20 has detected one or more objects as being in vicinity of an associated movable door member 310a-n. The objects may be any number of persons, vehicles, logistics arrangements, freight goods, animals, and so forth. The term “in vicinity of” is to be interpreted as close enough for the sensor units of the sensor module 20 to detect said objects, as determined by their respective detection sensitivities.

In either one of above described sensor module 20 embodiments, the safety signal represents sensor data. Sensor data is data related to the sensor module 20 and the detection of objects. Sensor data may, for instance, include either one of detection information, sensor module characteristics, maintenance information, process information or positional information. Detection information may be a simple “ON” or “OFF” value, corresponding to a detected object or not. Alternatively, detection information may be information related to what type of object is detected, how fast said detected object is moving and in what direction, where said object has been detected, and so forth. Sensor module characteristics may include information related to what type of sensor module 20 is used, and maintenance information thereof may be related to a date since the last maintenance session, status of internal components, and so forth. Process information may be related to how the operation of the entrance system is performing in terms of efficiency with respect to different threshold values. Positional information may be related to where the sensor module 20 is positioned with respect to the door members 310a-n and/or a ground or ceiling level.

In the simplest of embodiments, the sensor data may correspond to a high or a low value that represents whether or not an object has been detected. As such, the signal is toggling between low and high values upon detection of an object. This signal is transmitted to the controller module 30, which in response thereto retrieves the sensor data from the safety signal and interprets the information. In more sophisticated embodiments wherein the safety signal is modulated by the sensor module 20, the controller module 30 may implement different interpretation schemes for retrieval of sensor data from the safety signal. In order to provide sensor data along with the provided safety signal, different pulse width and/or frequency modulation techniques may be applied. Modulation techniques and interpretation schemes of the sensor data will be described in more detail later on in this disclosure.

The controller module 30 preferably comprises means for modulating a current of the safety signal provided by the sensor module 20. The modulated current will consequently represent control data, which means that the controller module 30 is configured to provide control data to the sensor module 20. Control data is related to control of the door members 310a-n and/or the sensor module 20. Control data may, for instance, include either one of installation parameters, entrance system characteristics, or maintenance information. Installation parameters may be related to set-up instructions of the sensor module 20. Such set-up instructions may include e.g. sensitivities, safety modes, ranges, signal strengths, battery modes, and so forth. Entrance system characteristics may include door member types, entrance system location and operation procedures, automatic door operator component information, and so forth. Maintenance information may include information related to date since the last maintenance session, status of internal components, and so forth.

In order to provide control data to the sensor module 20 by modulating a current of the safety signal, different amplitude modulation and interpretation schemes may be applied, which will also be discussed later on in this disclosure.

The control arrangement 100 is preferably configured to cause controlled actuation of the one or more door members 310a-n at least in part based on the sensor data. In response to having retrieved the sensor data, the control arrangement 100, and more specifically the controller module 30, is configured to provide a control decision. The control decision is an indication that one or more objects have been detected, and are thereby in the vicinity of the one or more movable door members 310a-n. The control decision therefore implicates that a controlled actuation of the one or more movable door members 310a-n is about to occur. Such controlled actuation involves inhibiting, stopping or reverting current or future movement of a specific door member 310a-n whereat the sensor module 20 has detected said one or more objects. In some embodiments, the control decision may also involve adjusting the angles or rotations of door leafs of the one or more movable door member 310a-n.

When the control decision has been provided, controlled actuation of a door member 310a-n is caused based on this control decision. In preferred embodiments, one or more control signals are generated once the control decision has been provided. The control signals may be transmitted to the drive unit 210 of the automatic door operator 200, or alternatively to an external drive unit. Movement of the one or more movable door members 310a-n as has been previously explained will be performed accordingly.

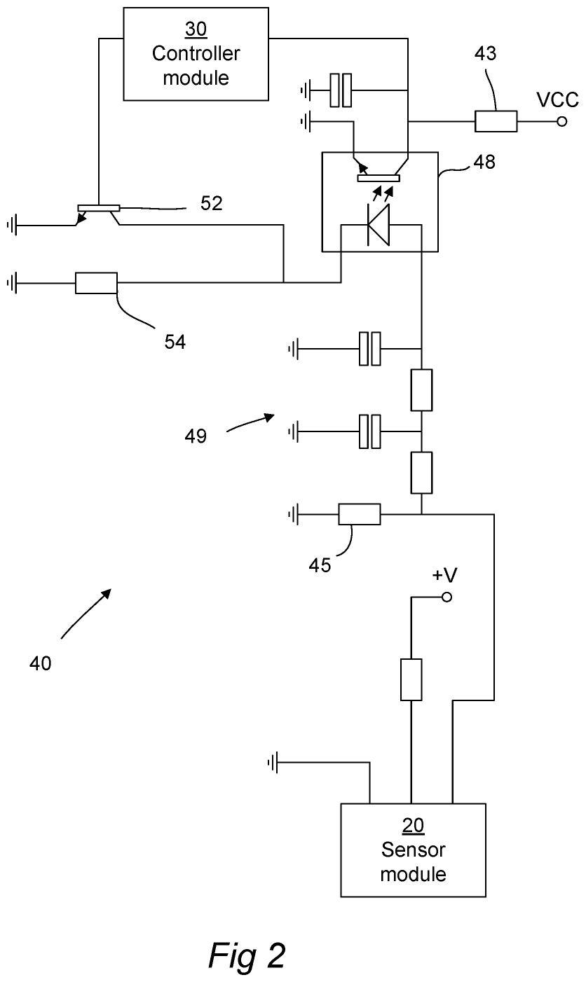

With reference to FIG. 2, an exemplary embodiment of a control arrangement 100 is shown. The control arrangement 100 is by no means limited to having the selected electronic components of FIG. 2. Persons skilled in the arts may realize other similar control arrangements 100 with some modifications, given that the control arrangement 100 is capable of providing sensor data from the sensor module 20 to the controller module 30, and control data from the controller module 30 to the sensor module 20.

The control arrangement 100 comprises an interface circuitry 40, wherein the sensor module 20 and the controller module 30 are coupled by means of said interface circuitry 40. A first end of the interface circuitry 40 is connected to the sensor module 20, and a second end is connected to the controller module 30. Hence, in this embodiment, serial data communication of the control data and the sensor data is enabled over a single wire. Since both safety signaling and serial data communication is being handled as one signal over the single wire, the number of pins required in the standard port of the controller module 30 is thereby reduced. Moreover, a universal sensor module 20 standard is achieved. This is achieved without failing to comply with required security standards for the entrance system 300. The control circuitry 40 further comprises an electronic filter 49, a pull-up load 43, a pull-down load 45, a galvanic isolator 48, a transistor unit 52 and a load 54.

The safety signal is transmitted from the sensor module 20, via the galvanic isolator 48, through the load 54 and finally to ground. The galvanic isolator 48 is in the figure realized as an optocoupler, although other electronic components may alternatively be applied. The sensor data will be transmitted to the controller module 30 via the galvanic isolator 48, wherein the controller module 30 retrieves the sensor data. The current of the safety signal is adapted to be modulated by modulating the electrical resistance of the load 54 through control of the transistor unit 52. Hence, the controller module 30 is configured to modulate the current of the safety signal passing through the load 54 by control of the transistor unit 52, wherein the load 54 and the transistor unit 52 are comprised in the interface circuitry 40. To this end, the controller module 30 may comprise a digital-to-analog converter unit (DAC) that is controlling the current of the base of the transistor unit 52. As such, the controller module 30 can generate a modulated current in a variety of different ways, representing control data. Instructions 31a for modulating the current of the safety signal may, for instance, be stored in the memory 31. The sensor module 20 is configured to measure the current of the safety signal using any known current measuring unit, e.g. an ammeter unit, thereby retrieving the control data from the modulated current.

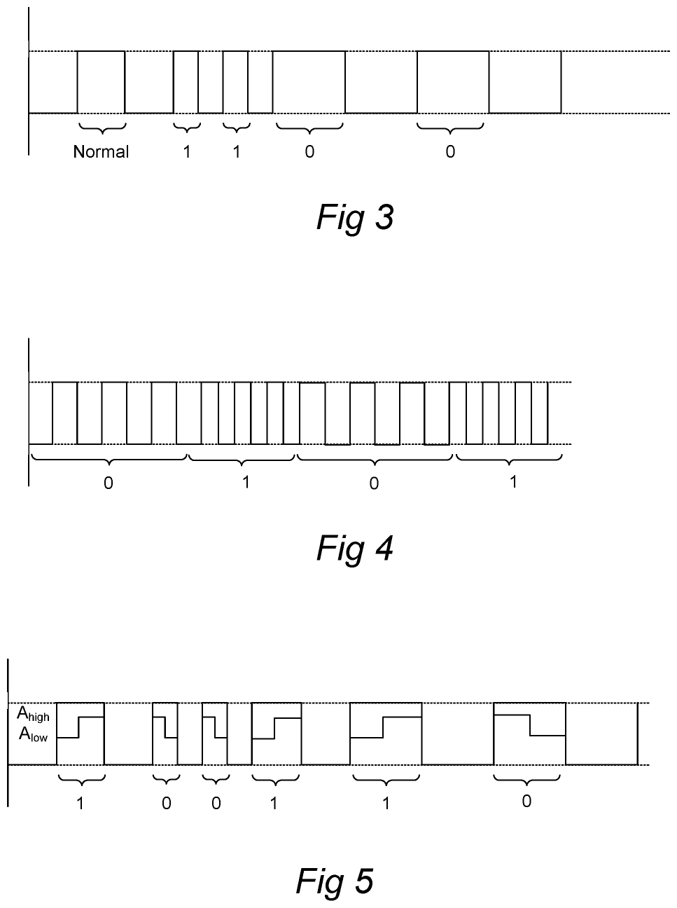

In the embodiment wherein the sensor module 20 is a “smart” sensor comprising a carrier wave generation unit, a pulse-width modulator unit, a frequency modulator unit and/or a processing unit, the sensor module 20 is configured to modulate the provided safety signal before it is transmitted to the controller module 30. Hence, in this embodiment, the interface circuitry 40 is a duplex communication interface capable of transmitting sensor data and control data over the same wire, in both directions, simultaneously. Instructions 21a for modulating the pulse-width and/or the frequency of the safety signal may, for instance, be stored in the memory 31. Different modulation and data representation techniques will now be described with reference to FIGS. 3, 4, 5 and 6a-b.

With reference to FIG. 3, an embodiment of pulse-width modulation of a safety signal is illustrated. The shown safety signal is a dynamic safety signal. The term “dynamic” is in this sense referring to the dynamic nature of how safety signals are generated. The dynamic safety signal as provided will, during some time intervals, always be either short-to-ground (low) or short-to-power (high). These time intervals typically correspond to the period during which an operation of a specific movable door member 310a-n is ongoing. Hence, the safety signal can be seen as “dynamic”, in the sense that it does not always comprise a static signal pattern toggling between a low and a high value. Because of the switches, a dynamic signal is outputted from the sensor module 20. Techniques for producing dynamic safety signals are, as such, known in the art. For instance, the sensor module 20 may comprise an Optical Safety Edge (OSE), producing a square wave of frequencies ranging between 200 Hz to 2 kHz. Alternatively, technologies based on generating a so-called FSS-signal, may be applied. FSS-signals are square waves having a frequency generally around 1 kHz. In alternative embodiments, any other dynamic safety signal with an appropriate frequency range for controller modules 30 in automatic door operators 200 may be used.

The dynamic safety signal shown in FIG. 3 comprises a plurality of pulses, and the sensor module 20 is configured to modulate the pulse widths of the plurality of pulses. Hence, the modulated pulses may be shorter, or alternatively longer, compared to a normal pulse width of the dynamic safety signal. In the exemplary figure, a shorter pulse width is in this case represented as a ‘1’ and a longer pulse width is represented as a ‘0’. Thus, the controller module 30 can in this particular example interpret the sensor data as either four different signals, each corresponding to one bit, i.e. “1”, “1”, “0” and “0”. Alternatively, the controller module 30 can in this particular example interpret the sensor data as a composite signal corresponding to four bits, i.e. “1100”. Persons skilled in the art realize that pulse-width modulation can be performed in a wide variety of different ways. For instance, each pulse may be modulated into an arbitrary number of pulse widths of arbitrary pulse width, wherein each pulse width represents an arbitrary number of bits. As such, the modulated pulse widths for each dynamic safety signal represents a bit pattern comprising at least one bit, wherein the controller module 30 is configured to retrieve the sensor data by translating said bit pattern representation.

With reference to FIG. 4, an embodiment of frequency modulation of a dynamic safety signal is shown. The dynamic safety signal comprises a plurality of pulses appearing at a predetermined frequency. The sensor module 20 is configured to modulate a predetermined frequency (e.g. 1 kHz) of the dynamic safety signal. Hence, the plurality of pulses of the dynamic safety signal may appear more frequently, or alternatively less frequently, compared to the predetermined frequency. In the exemplary figure, a higher frequency is in this case represented as a ‘1’ and a lower frequency is represented as a ‘0’. Thus, the controller module 30 can in this particular example interpret the sensor data as four different signals, each corresponding to one bit, i.e. “0”, “1”, “0” and “1”. Alternatively, the controller module 30 can in this particular example interpret the sensor data as a composite signal corresponding to four bits, i.e. “0101”. Persons skilled in the art realize that frequency modulation can be performed in a wide variety of different ways. For instance, an arbitrary number of pulses may be modulated into an arbitrary number of frequencies, wherein each modulated frequency represents an arbitrary number of bits. As such, the modulated frequencies for each dynamic safety signal represents a bit pattern comprising at least one bit, wherein the controller module 30 is configured to retrieve the sensor data by translating said bit pattern representation.

In alternative embodiments, both frequency modulation as well as pulse-width modulation can be performed on the dynamic safety signals simultaneously, to provide yet additional bit pattern representations for the sensor data.

With reference to FIG. 5, an embodiment of current modulation of a safety signal is shown. Current modulation may be applied on both dynamic safety signals as well as simple safety signals generated by e.g. a NPN/PNP-based sensor. The exemplary signal shown in FIG. 5 has also been pulse-width modulated, although this is not a requirement in order to perform current modulation thereof. Alternatively, frequency modulation thereof, or a combination of frequency modulation and pulse-width modulation could potentially also be performed, while still being able to perform current modulation.

As was explained with reference to FIG. 2, the controller module 30 is configured to modulate the current of the safety signal by modulating the electrical resistance of the load 54 through control of the transistor unit 52. The modulated current of the safety signal seen in FIG. 5 ranges between a high value A_{high} and a low value A_{low}. Depending on the transitions between the high value A_{high} and the low value A_{low}, the control data may be represented differently. In FIG. 5, a ‘1’ is represented as a positive edge and a ‘0’ is represented as a negative edge. Hence, the safety signal may in this case be interpreted as either one of six separate bits of information, representing “1”, “0”, “0”, “1”, “1”, and “0”, or alternatively a composite signal of six bits, representing “100110”.

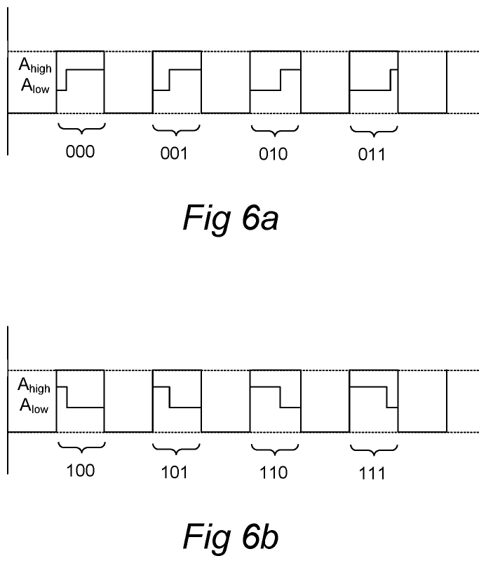

In FIGS. 6a-b, another exemplary signal is shown, which has been current modulated by the controller module 30. In this particular example, each pulse is representing a bit pattern of three bits, depending on when the positive or negative edge occur. In FIG. 6a, four different positive edges are thus representing “000”, “001”, “010” and “011”, whereas four different negative edges are representing “100”, “101”, “110”, and “111”. The control data may thus be interpreted as either one of the three-bit patterns above, or alternatively a composite signal of 24 bits, i.e. “000001010011100101110111”.

Persons skilled in the art realize that current modulation can be performed in a wide variety of different ways. For instance, an arbitrary number of positive or negative edges of different appearances may represents an arbitrary number of bits. As such, the modulated current for each (dynamic) safety signal represents a bit pattern comprising at least one bit, wherein the sensor module 20 is configured to retrieve the sensor data by translating said bit pattern representation.

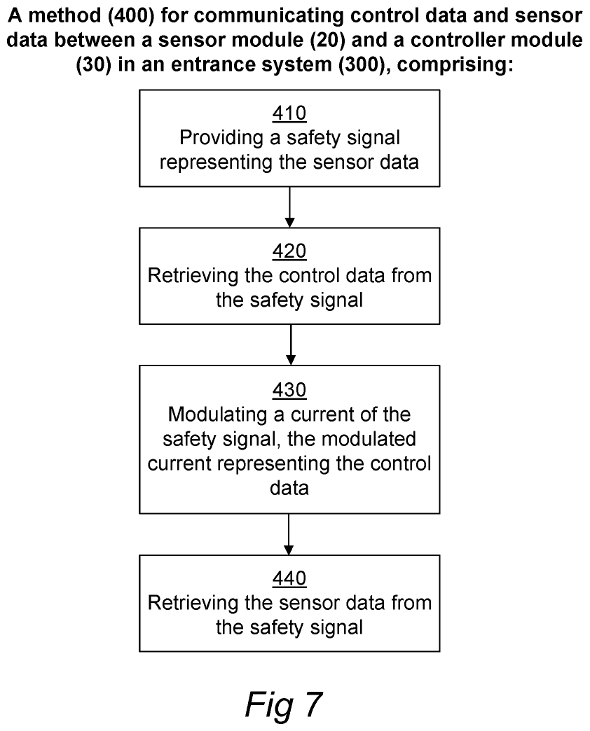

With reference to FIG. 7, a method 400 for communicating control data and sensor data between a sensor module 20 and a controller module 30 in an entrance system 300 is shown. The method 400 comprises a step of providing 410 a safety signal representing the sensor data. The method 400 further comprises a step of retrieving 420 the control data from the safety signal. The method 400 further comprises a step of modulating 430 a current of the safety signal, the modulated current representing the control data. The method 400 further comprises a step of retrieving 440 the sensor data from the safety signal. The method 400 is generally to be performed in accordance with the technical provisions presented in the present disclosure.

In embodiments of the invention according to any of the figures disclosed herein, a computer program product comprising computer code for performing the method 400 when the computer program code is executed by a processing device may be provided. The processing device may in preferred embodiments of the invention be the controller module 30 and/or the sensor module 20 as disclosed herein. Alternatively, the processing unit may be provided separately and be implemented using any similar controller technology as described in association with the controller module 30 and/or the sensor module 20.

The invention has been described above in detail with reference to embodiments thereof. However, as is readily understood by those skilled in the art, other embodiments are equally possible within the scope of the present invention, as defined by the appended claims. It is recalled that the invention may generally be applied in or to an entrance system 300 having one or more movable door member not limited to any specific type. Each such door member may, for instance, be a swing door member, a revolving door member, a sliding door member, an overhead sectional door member, a horizontal folding door member or a pull-up (vertical lifting) door member.

1. A control arrangement (100) for an entrance system (300), comprising a controller module (30) and a sensor module (20), the controller module (30) being for providing control data to the sensor module (20) and the sensor module (20) being for providing sensor data to the controller module (30), said sensor module (20) being configured to:
provide a safety signal representing the sensor data, and
retrieve the control data from the safety signal;
said controller module (30) being configured to:
modulate a current of the safety signal, the modulated current representing the control data, and
retrieve the sensor data from the safety signal.

2. The control arrangement (100) according to claim 1, wherein the safety signal is a dynamic safety signal comprising a plurality of pulses, wherein the sensor module (20) is configured to modulate pulse widths of said plurality of pulses, said modulated pulse widths representing a bit pattern comprising at least one bit, wherein the controller module (30) is configured to retrieve the sensor data by translating said bit pattern representation.

3. The control arrangement (100) according to claim 1, wherein the safety signal is a dynamic safety signal comprising a plurality of pulses appearing at a predetermined frequency, wherein the sensor module (20) is configured to modulate the predetermined frequency, said modulated frequency representing a bit pattern comprising at least one bit, wherein the controller module (30) is configured to retrieve 30 the sensor data by translating said bit pattern representation.

4. The control arrangement (100) according to claim 2, wherein the sensor data includes detection information, sensor module characteristics, maintenance information, process information and/or positional information.

5. The control arrangement (100) according to claim 1, further comprising an interface circuitry (40), wherein the sensor module (20) and the controller module (30) are coupled by means of said interface circuitry (40) over a 10 single wire.

6. The control arrangement (100) according to claim 5, wherein the interface circuitry (40) is a duplex communication interface.

7. The control arrangement (100) according to claim 5, wherein the interface circuitry (40) is adapted to provide galvanic isolation between the sensor module (20) and the controller module (30).

8. The control arrangement (100) according to claim 5, wherein the interface circuitry (40) comprises a transistor unit (52) and a load (54), and wherein the controller module (30) is configured to modulate the electrical resistance of the load (54) through control of the transistor unit (52).

9. The control arrangement (100) according to claim 8, wherein modulating the electrical resistance of the load (54) generates said modulated current, said modulated current representing a bit pattern comprising at least one bit, wherein the sensor module (20) is configured to retrieve control data from the one or more dynamic safety signals by translating said bit pattern representation.

10. The control arrangement (100) according to claim 1, wherein said control data comprises at least one of installation parameters, entrance system characteristics and/or maintenance information.

11. The control arrangement (100) according to claim 1, wherein the sensor module (20) comprises one or more sensor units, said one or more sensor units being:
optical sensors;
ultrasonic sensors;
inductive sensors;
galvanic sensors;
magnetic sensors;
photoelectric sensors;
capacitive sensors;
pneumatic sensors;
weight or pressure sensors;
cameras;
electromechanical switches; or
any combination thereof.

12. An automatic door operator (200) comprising a control arrangement (100) according to claim 1.

13. An entrance system (300) comprising an automatic door operator (200) according to claim 12 and one or more movable door members (310a-n), wherein the control arrangement (100) is configured to cause controlled actuation of the one or more movable door members (310a-n) at least in part based on the sensor data.

14. The entrance system (300) according to claim 13, wherein said controlled actuation involves inhibiting, stopping or reverting current or future movement of at least one of the one or more movable door members (310a-n).

15. A method (400) for communicating control data and sensor data between a sensor module (20) and a controller module (30) in an entrance system (300), the method (400) comprising:
providing (410) a safety signal representing the sensor data;
retrieving (420) the control data from the safety signal;
modulating (430) a current of the safety signal, the modulated current
representing the control data; and
retrieving (440) the sensor data from the safety signal.
